(19) United States
(12) Patent Application Publication
(10) Pub. No.: US 2016/0181889 A1
(43) Pub. Date: Jun. 23, 2016

(54) SLIDE-TYPE ACTUATOR

(71) Applicants: Chin-Hsing Feng, Taoyuan County (TW); Jii-Chyun Wang, Taoyuan County (TW)

(72) Inventors: Chin-Hsing Feng, Taoyuan County (TW); Jii-Chyun Wang, Taoyuan County (TW)

(21) Appl. No.: 14/579,485

(22) Filed: Dec. 22, 2014

(51) Int. Cl. H02K 7/06

(52) U.S. Cl. CPC H02K 7/06

(57) ABSTRACT

A slide-type actuator includes a fixing unit, a drive unit, a rotating unit, and a traction unit. The drive unit can slide relative to the fixing unit for reciprocation. The rotating unit is disposed on the fixing unit. After the traction unit is wound on the rotating unit, two ends of the traction unit are connected to turning members of the fixing unit and the drive unit, respectively. When the drive unit slides relative to the fixing unit, the traction unit is pulled to actuate the rotating unit. Through reciprocating motion, the rotating unit is turned clockwise and counterclockwise. An output end of the rotating unit is adapted to generate electric power.

### BACKGROUND OF THE INVENTION

1. Field of the Invention

The present invention relates to an actuator, and more particularly to a slide-type actuator which can provide a multiple of a single route to generate electric power.

2. Description of the Prior Art

In general, the way to generate electric power includes wind power, thermal power, nuclear power, hydropower, solar power, etc. Wherein, wind power, hydropower, and solar power are environment-friendly without pollution, but subject to climatic factors. Thermal power and nuclear power have a disadvantage of environmental pollution. Especially, the nuclear power may bring a disaster, such as the disaster occurred in Fukushima, Japan. The forgoing various ways to generate power need a large investment and the equipment is quite complex and giant.

As the population in many countries rises quickly, but the construction of power generation equipment is slow. Many countries are facing a difficulty in inadequate use of electricity. Furthermore, people pay more attention to the issues of environmental protection and safety. How to supply electricity effectively and how to conform to environment protection and energy-saving and safety demand are important issues.

In these days, people have a certain demand for various portable electric products, such as smart phones, tablet PCs, notebook computers, and so on. When people go out, they may have the demand for electricity. It is necessary to design a small, portable and green power generation device. Accordingly, the inventor of the present invention has devoted himself based on his many years of practical experiences to solve these problems.

### SUMMARY OF THE INVENTION

To improve pollution and other limitations of the conventional way to generate electric power, the primary object of the present invention is to provide a slide-type actuator. The actuator provides green energy and is small in size and is efficient without pollution, which is able to generate electric power anywhere and anytime.

In order to achieve the aforesaid object, the present invention provides a drive unit to slide relative to a fixing unit. A traction unit is pulled to actuate a rotating unit. Through reciprocating motion, the rotating unit is turned clockwise and counterclockwise. An output end of the rotating unit is adapted to generate electric power.

The slide-type actuator according to a preferred embodiment of the present invention comprises a fixing unit, a drive unit, a rotating unit, and a traction unit.

The fixing unit has a space therein. Two sides of the fixing unit each are provided with at least one first turning member. The first turning member is disposed on a board.

The drive unit is coupled to the space of the fixing unit. The fixing unit can be used to prevent the drive unit from disengagement. Two sides of the drive unit each are provided with at least one second turning member.

The rotating unit is disposed on the fixing unit and adapted for pivot motion.

The traction unit is a long rope. After the traction unit is wound on the rotating unit, two ends of the traction unit respectively pass through the first turning member and the corresponding second turning member in sequence.

The rotating unit has an output end which is connected with a generator unit.

Except the turning member located at the distal end of the traction unit to provide a fixing function, the other turning members provide a turning function.

### BRIEF DESCRIPTION OF THE DRAWINGS

FIG. 1 is a perspective view according to a preferred embodiment of the present invention;

FIG. 2 is a schematic view according to the preferred embodiment of the present invention;

FIG. 3 is a schematic view showing that the drive unit of the present invention is slid toward the left of the drawing; and

FIG. 4 is a schematic view showing that the drive unit of the present invention is slid toward the right of the drawing.

### DETAILED DESCRIPTION OF THE PREFERRED EMBODIMENTS

Embodiments of the present invention will now be described, by way of example only, with reference to the accompanying drawings.

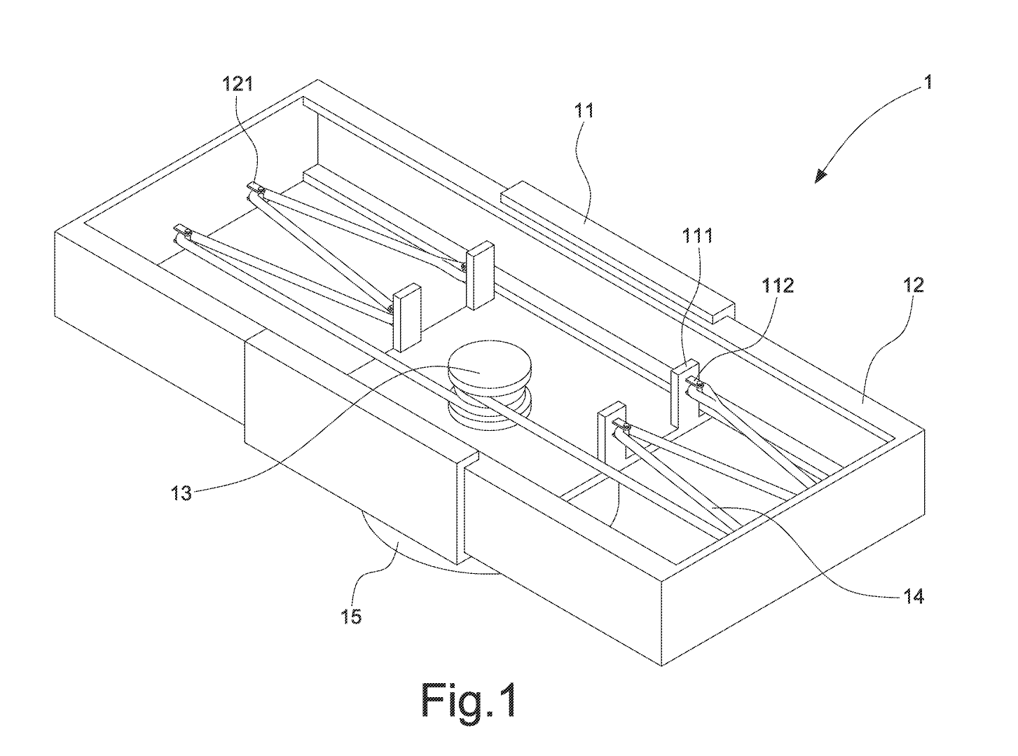

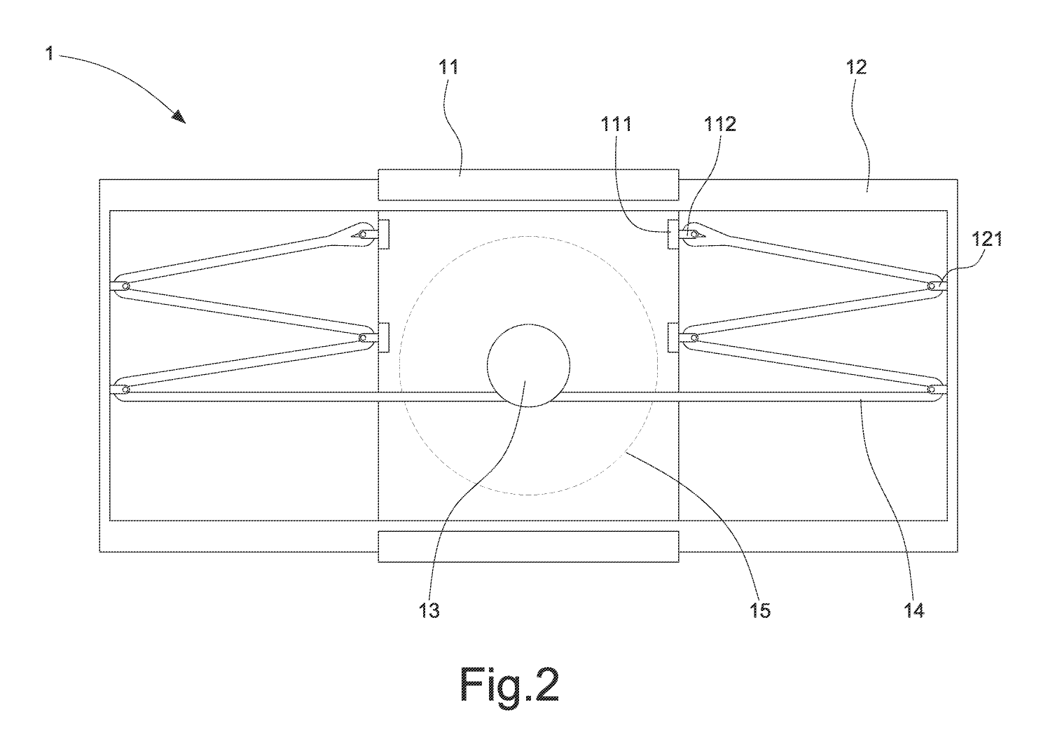

As shown in FIG. 1 and FIG. 2, the slide-type actuator according to a preferred embodiment of the present invention comprises a fixing unit 11, a drive unit 12, a rotating unit 13, and a traction unit 14.

The fixing unit 11 has a space therein. Two sides of the fixing unit 11 each are provided with at least one first turning member 112. The first turning member 112 is disposed on a board 111.

The drive unit 12 is coupled to the space of the fixing unit 11. The fixing unit 11 can be used to prevent the drive unit 12 from disengagement. Two sides of the drive unit 12 each are provided with at least one second turning member 121.

The rotating unit 13 is disposed on the fixing unit 11 and adapted for pivot motion.

The traction unit 14 is a long rope. After the traction unit 14 is wound on the rotating unit 13, two ends of the traction unit 14 respectively pass through the second turning member 121 and the corresponding first turning member 112 in sequence.

The rotating unit 13 has an output end which is connected with a generator unit 15.

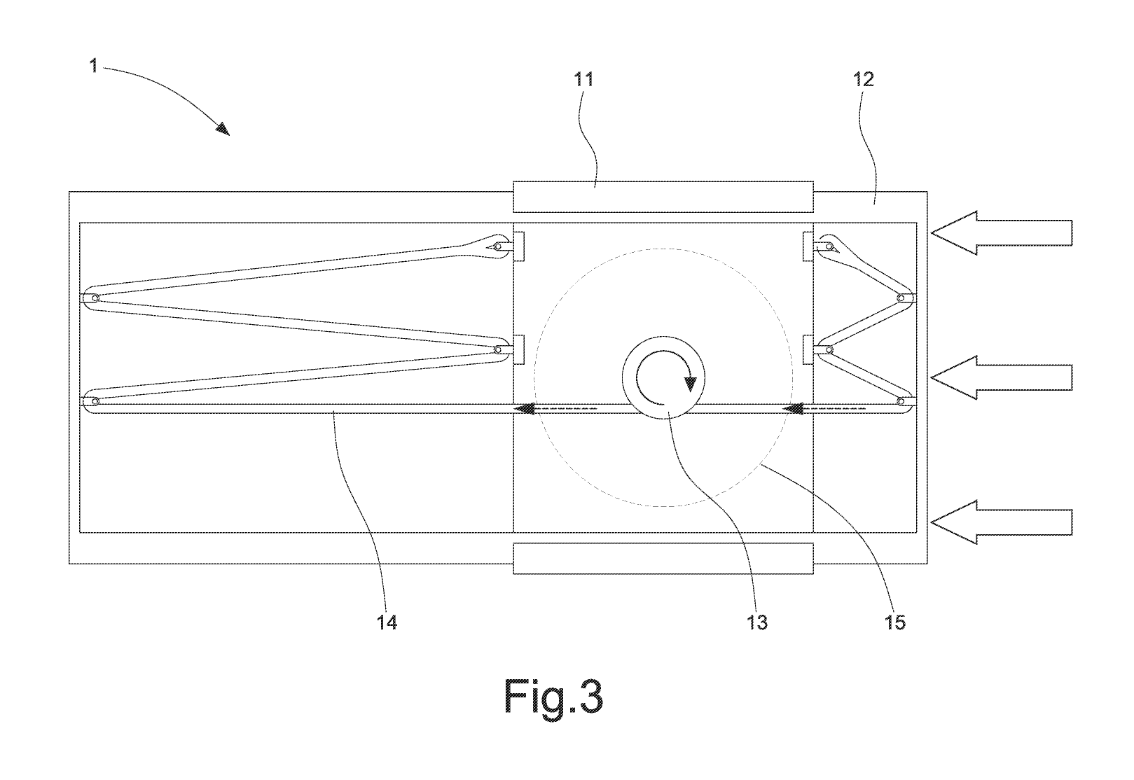

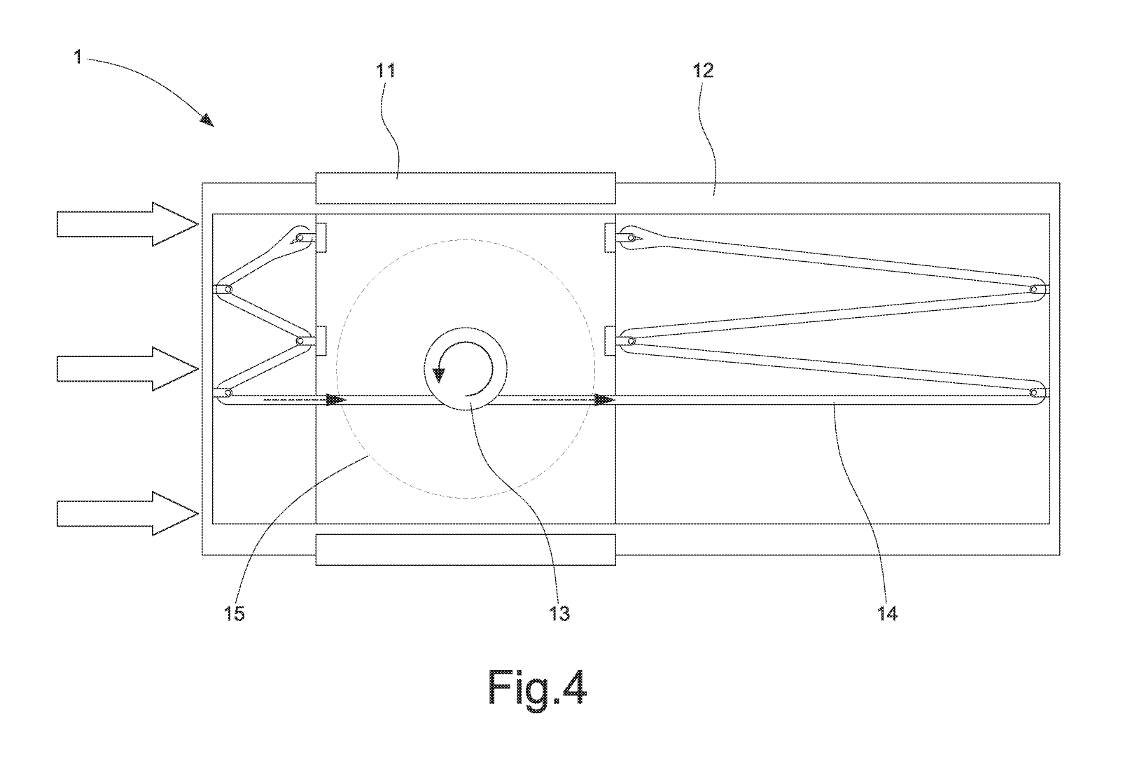

As shown in FIG. 3, to practice the present invention, the drive unit 12 is applied with an external force to move left relative to the fixing unit 11. A portion of the traction unit 14 is moved left along with the movement of the drive unit 12, such that the rotating unit 13 is rotated to actuate. As shown in FIG. 4, the drive unit 12 is applied with another external force to move right relative to the fixing unit 11. A portion of the traction unit 14 is moved right along with the movement of the drive unit 12, such that the rotating unit 13 is reversely rotated to actuate. Through reciprocating motion, the rotating unit 13 is turned clockwise and counterclockwise. The output end of the rotating unit 13 is connected with the generator unit 15 to generate power.

The number of the first turning member 112 and the second turning member 121 can be increased or decreased according to the demand. The last tuning member disposed on the fixing unit 11 or the drive unit 12 can be changed to provide a fixing function or a slide function.

The feature of the present invention is that the actuator is provided with a plurality of first turning members 112 and second turning members 121 and only a single traction route is required to provide a multiple of the route so as to enhance its efficiency. The present invention has economic benefits.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A slide-type actuator, comprising:
a fixing unit having a space therein, two sides of the fixing unit each being provided with at least one first turning member;
a drive unit coupled to the space of the fixing unit, two sides of the drive unit each being provided with at least one second turning member;
a rotating unit disposed on the fixing unit and adapted for pivot motion; and
a traction unit, the traction unit being wound on the rotating unit and having two ends, the two ends of the traction unit respectively passing through the at least one first turning member and the at least one second turning member.

2. The slide-type actuator as claimed in claim 1, wherein the first turning member is disposed on a board, and the board is disposed on the fixing unit.

3. The slide-type actuator as claimed in claim 1, wherein the traction unit is a rope.

4. The slide-type actuator as claimed in claim 1, wherein the rotating unit has an output end which is connected with a generator unit.
